(19) United States
(12) Patent Application Publication
(10) Pub. No.: US 2009/0216756 A1
(43) Pub. Date: Aug. 27, 2009

(54) RECORDING MEDIUM CARRYING DATA SEARCH PROGRAM, DATA SEARCH APPARATUS, AND DATA SEARCH METHOD

(75) Inventor: Hidekazu Arao, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/390,934

(22) Filed: Feb. 23, 2009

(30) Foreign Application Priority Data
Feb. 26, 2008 (JP) 2008-044418

(51) Int. Cl. G06F 17/30

(52) U.S. Cl. 707/5; 707/E17.014

(57) ABSTRACT

A data search apparatus searches for target data based on a keyword included in the target data, and classification information indicating classification of the target data.

### CROSS-REFERENCE TO RELATED APPLICATION

This application is based upon and claims the benefit of priority of the prior Japanese Patent Application No. 2008-44418, filed on Feb. 26, 2008 the entire contents of which are incorporated herein by reference.

### FIELD

The present invention relates to a recording medium carrying a data search program to search for target data, a data search apparatus, and a data search method. More specifically, the present invention relates to a recording medium carrying a data search program capable of efficiently searching for target data without increasing a load for operation/maintenance, a data search apparatus, and a data search method.

### BACKGROUND

In recent years, a wide variety of information has been available as electronic data with the spread of information processing technologies. Such circumstances contribute to enhancement of convenience, while causing difficulty for users in finding a necessary piece of information among many pieces of information.

As measures against such inconvenience, the following technique has been widely used. That is, electronic data is classified in advance and a search screen to search for electronic data based on the classification is provided so that a user can easily find necessary information. By using this technique, the user can narrow down information to search for only by selecting presented choices in the search screen.

However, in the above-described method of using a search screen to search for electronic data based on classification, a database to manage the correspondence between choices on the search screen and electronic data needs to be provided. Maintenance of the database is a troublesome task.

### SUMMARY

The present invention has been made to solve the above-described problems in the related art, and an object of the present invention is to provide a recording medium carrying a data search program capable of efficiently searching for electronic data without increasing a load for operation/maintenance, a data search apparatus, and a data search method.

In order to solve the above-described problems and to achieve the object, a data search apparatus disclosed in this application is a data search apparatus to search for target data based on a keyword included in the target data and classification information indicating classification of the target data. The data search apparatus includes search condition accepting means for accepting the keyword and the classification information as search conditions; first search means for searching for search data that is generated in tandem with the target data and that holds position information indicating a position of corresponding target data and classification information of the corresponding target data while associating the position information with the classification information, and selecting search data holding the classification information accepted by the search condition accepting means; second search means for searching for target data indicated by the position information held in the search data selected by the first search means and selecting target data including the keyword accepted by the search condition accepting means; and search result output means for outputting information about the target data selected by the second search means.

Also, the above-described problems can be effectively solved by applying the elements, representation, or an arbitrary combination of the elements of the data search apparatus to a method, an apparatus, a system, a computer program, a recording medium, or a data structure.

### BRIEF DESCRIPTION OF THE DRAWINGS

FIG. 1 illustrates an outline of a data search method according to an embodiment;

FIG. 2 is a functional block diagram illustrating a configuration of a data search apparatus according to the embodiment;

FIG. 3 illustrates an example of a classification information master;

FIG. 4 illustrates an example of search data;

FIG. 5 illustrates an example of a search data generating screen;

FIG. 6 illustrates an example of a search screen;

FIG. 7 illustrates an example of a search result screen;

FIG. 8 illustrates an example of an HTML source in an unregistered classification area;

FIG. 9 is a flowchart illustrating a procedure of a search process performed by the data search apparatus;

FIG. 10 is a flowchart illustrating a procedure of a primary search process;

FIG. 11 is a flowchart illustrating a procedure of a secondary search process;

FIG. 12 is a flowchart illustrating a procedure of a search result file generating process;

FIG. 13 a flowchart illustrating the procedure of the search result file generating process; and

FIG. 14 is a functional block diagram illustrating a computer executing a data search program.

### DESCRIPTION OF EMBODIMENT

Hereinafter, a recording medium carrying a data search program, a data search apparatus, and a data search method according to a preferred embodiment of the present invention are described in detail with reference to the attached drawings.

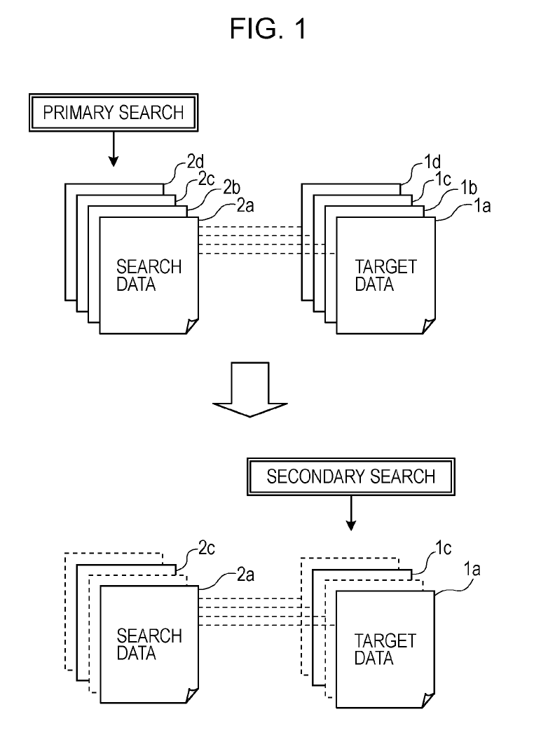

First, an outline of the data search method according to the embodiment is described. FIG. 1 illustrates the outline of the data search method according to the embodiment. As illustrated in FIG. 1, the data search method according to the embodiment is based on the assumption that pieces of search data 2a to 2d are generated in pairs with pieces of target data 1a to 1d which are electronic data as search target.

Each of the pieces of search data 2a to 2d holds position information indicating the position of a corresponding piece of target data and information necessary to search for the corresponding piece of target data, and is generated in a predetermined format. The position information is held in the format of URL (Uniform Resource Locator) or UNC (Universal Naming Convention), for example. Here, the information necessary to search for a piece of target data includes classification information indicating a class based on a predetermined classification system to which the target data belongs, and a keyword which is a representative word clearly representing the content of the target data among words included in the target data.

In the data search method according to the embodiment, a user specifies search conditions on a predetermined search screen and provides instructions to execute the search. Then matching with the search conditions is performed on the pieces of search data 2a to 2d as a primary search. Only in the case where further matching is required as a result of the primary search, is secondary search performed. That is, matching is performed on target data obtained by narrowing down the pieces of target data 1a to 1d in the primary search. In the example illustrated in FIG. 1, matching is performed on only the pieces of target data 1a and 1c in the secondary search as a result of the primary search.

The pieces of search data 2a to 2d hold a relatively small amount of information, and thus the time required for matching is shorter compared to the pieces of target data 1a to 1d that can hold a very large amount of information. Therefore, the above-described method of performing primary search on the pieces of search data 2a to 2d in order to narrow down the target data on which matching is performed in secondary search has an advantage of significantly reducing search time.

The pieces of search data 2a to 2d have a simple format, such as an XML (Extensible Markup Language), and can be easily generated by a user who wants to add a new piece of target data to a search target. Also, the pieces of search data 2a to 2d can be used for data search after being stored in a predetermined place on a network. Thus, in the data search method according to the embodiment, there is no need to use a database that is managed in a centralized manner in order to realize data search, so that time and trouble for operation/management can be reduced.

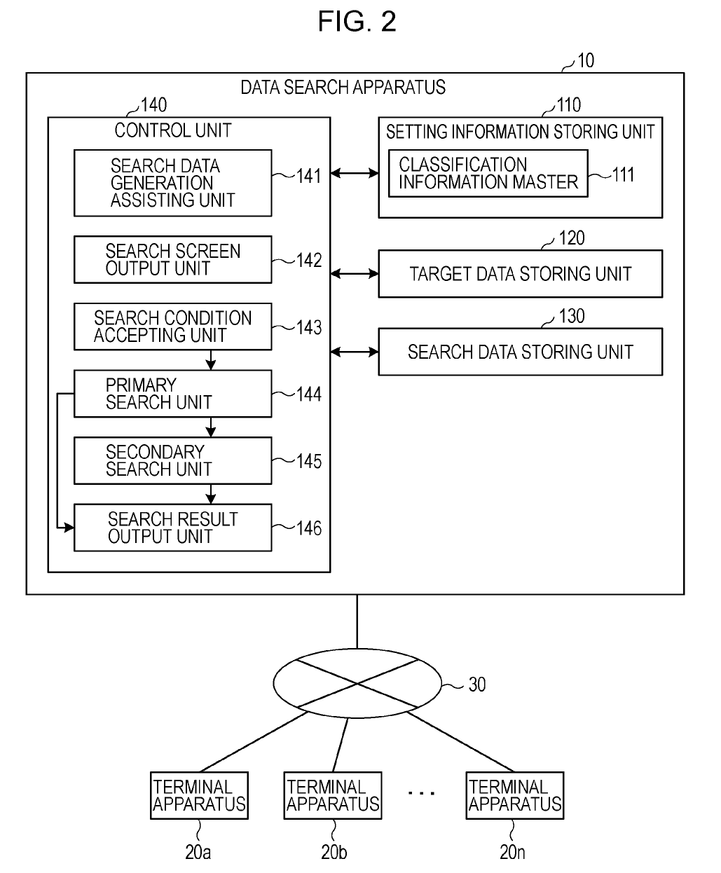

Next, a data search apparatus 10 to execute the data search method according to the embodiment is described. FIG. 2 is a functional block diagram illustrating a configuration of the data search apparatus 10 according to the embodiment. As illustrated in FIG. 2, the data search apparatus 10 connects to terminal apparatuses 20a to 20n via a network 30, such as a LAN (Local Area Network). The terminal apparatuses 20a to 20n are operated by users who request data searches by the data search apparatus 10 and correspond to personal computers, for example.

The data search apparatus 10 includes a setting information storing unit 110; a target data storing unit 120; a search data storing unit 130; and a control unit 140. The setting information storing unit 110 is a storing unit to store various pieces of setting information about an operation of the data search apparatus 10. The various pieces of setting information stored in the setting information storing unit 110 include a classification information master 111.

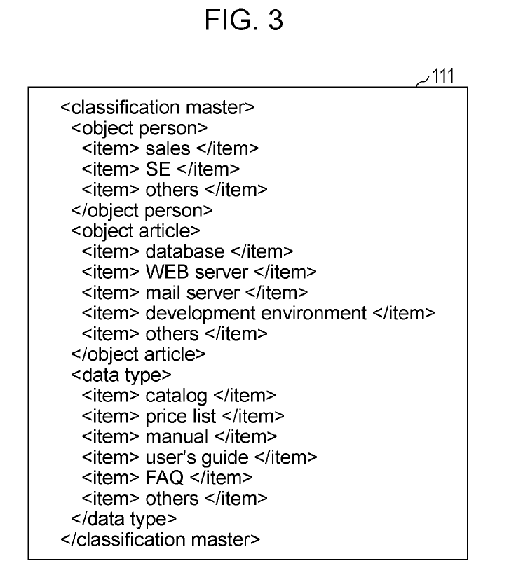

FIG. 3 illustrates an example of the classification information master 111. As illustrated in FIG. 3, the classification information master 111 is information indicating a classification system that is predefined to classify target data. In this example, the classification information master 111 is generated in the XML format and defines classification names to classify target data from three points of view: “object person”; “object article”; and “data type”.

Specifically, the classification information master 111 in the example illustrated in FIG. 3 indicates that target data belongs to any of classification names “sales”, “SE”, and “others” from the viewpoint of “object person”; any of classification names “database”, “WEB server”, “mail server”, “development environment”, and “others” from the viewpoint of “object article; and any of classification names “catalog”, “price list”, “manual”, “user's guide”, “FAQ”, and “others” from the viewpoint of “data type”.

Referring back to FIG. 2, the target data storing unit 120 is a storing unit to store target data, such as the pieces of target data 1a to 1d illustrated in FIG. 1. The target data stored in the target data storing unit 120 may have any format. For example, the target data stored in the target data storing unit 120 may be data in the HTML (HyperText Markup Language) format or word processor data generated by a word processor program.

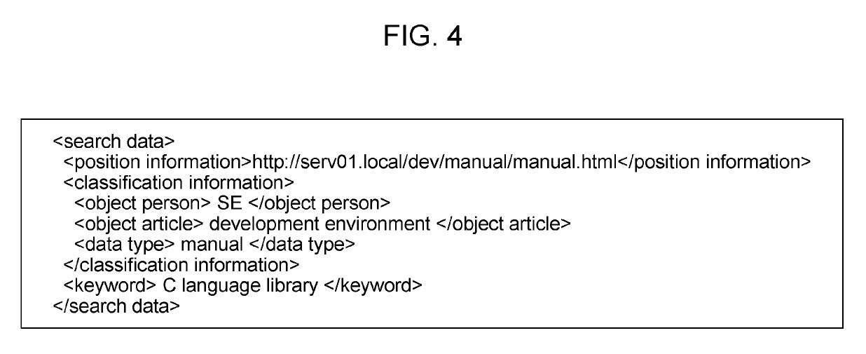

The search data storing unit 130 is a storing unit to store search data, such as the pieces of search data 2a to 2d illustrated in FIG. 1. Each piece of the search data is generated in a pair with a corresponding piece of the target data stored in the target data storing unit 120 and is stored in the search data storing unit 130. An example of the search data is illustrated in FIG. 4. In this example, the search data is generated in the XML format and holds the URL of the corresponding target data as position information. The search data in this example also holds classification information indicating that the corresponding target data belongs to the classification name “SE” from the viewpoint of “object person”; the classification name “development environment” from the viewpoint of “object article”; and the classification name “manual” from the viewpoint of “data type”. Also, the search data in this example holds two keywords “C language” and “library” that are included in the corresponding target data.

The target data storing unit 120 and the search data storing unit 130 need not always be placed inside the data search apparatus 10, and may be placed in an information processing apparatus connected to the data search apparatus 10 via a network. Furthermore, each of the target data storing unit 120 and the search data storing unit 130 need not always be a single apparatus, and may be distributed to a plurality of apparatuses on the network.

Any method may be used as a method for accessing, from the data search apparatus 10 or the terminal apparatuses 20a to 20n, the target data stored in the target data storing unit 120 or the search data stored in the search data storing unit 130. For example, a file transfer protocol such as HTTP (Hypertext Transfer Protocol) or FTP (File Transfer Protocol) may be used, or a file sharing protocol such as NFS (Network File System) may be used. Alternatively, a plurality of methods may be used by appropriately combining them.

The control unit 140 is a control unit to control the entire data search apparatus 10 and includes a search data generation assisting unit 141; a search screen output unit 142; a search condition accepting unit 143; a primary search unit 144; a secondary search unit 145; and a search result output unit 146.

The search data generation assisting unit 141 is a processing unit to assist an operation of generating search data. Specifically, the search data generation assisting unit 141 receives a request from any of the terminal apparatuses 20a to 20n, allows the terminal apparatus as a source of the request to display a search data generating screen 21 to input information necessary to generate search data, generates search data based on the information input on the search data generating screen 21, and stores the generated search data in the search data storing unit 130.

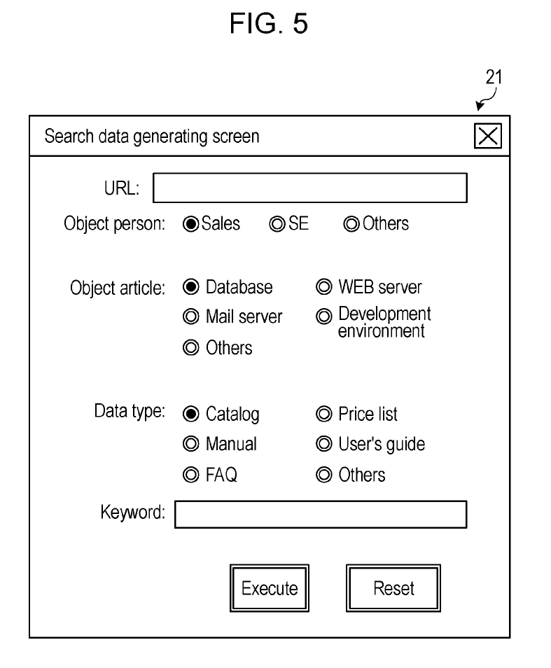

FIG. 5 illustrates an example of the search data generating screen 21. Display of the search data generating screen 21 is realized when the search data generation assisting unit 141 generates an HTML file to display the screen and transmits the HTML file to a WEB browser provided in the terminal apparatus as a source of the request, for example. The search data generating screen 21 illustrated in FIG. 5 is provided with an input field to input a URL as position information of corresponding target data; choices to select classification information; and an input field to input a keyword included in the corresponding target data. The choices to select classification information are automatically generated in accordance with the content of the classification information master 111. If the content of the classification information master 111 is changed by an administrator or the like, the choices to be displayed are also changed in accordance with the changed content. Upon press of an execution button after input has been completed, the input information is transmitted to the search data generation assisting unit 141.

In this way, by using the search data generating screen 21 provided by the search data generation assisting unit 141, a user who wants to release a new piece of target data can easily generate search data and store the search data in the search data storing unit 130. The target data may be stored in the target data storing unit 120 in an ordinary method. The search data need not always be generated by using the search data generating screen 21. For example, the search data may be generated by using an editor program in the terminal apparatuses 20a to 20n.

The search screen output unit 142 is a processing unit to allow the terminal apparatus as a source of a request to display a search screen 22 where the user inputs search conditions to search for target data in response to the request from any of the terminal apparatuses 20a to 20n.

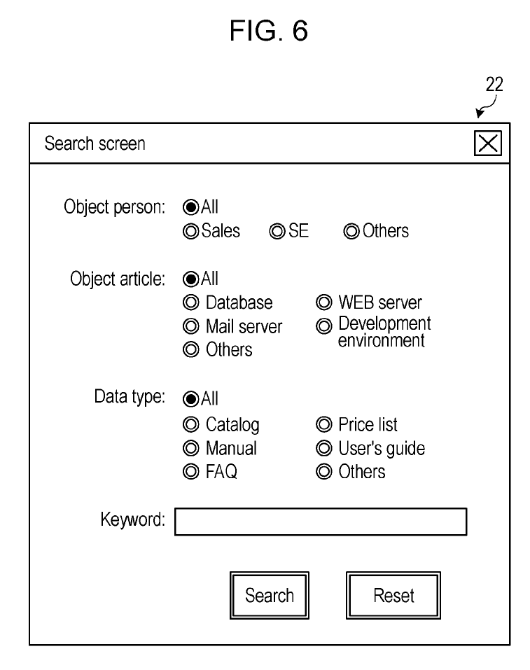

FIG. 6 illustrates an example of the search screen 22. Display of the search screen 22 is realized when the search screen output unit 142 generates an HTML file to display this screen and transmits the HTML file to a WEB browser provided in the terminal apparatus as a source of the request, for example. The search screen 22 illustrated in FIG. 6 is provided with choices to select classification information and an input field to input a keyword included in target data. The choices to select classification information are automatically generated in accordance with the content of the classification information master 111. Upon press of a search button after input of search conditions has been completed, the input search conditions are transmitted to the search condition accepting unit 143. Transmission of the search conditions is realized by a GET request or a POST request of HTTP.

In the example illustrated in FIG. 6, classification information and a keyword of target data to be searched for are specified. Additionally, update time of target data to be searched for, or classification information and position information of the target to be eliminated from the target, may be input as a target condition.

The search condition accepting unit 143 is a processing unit to accept search conditions input on the search screen 22. The search conditions accepted by the search condition accepting unit 143 include at least classification information and a keyword. The keyword may be an empty character string. When an empty keyword is input, the content of target data is not specified.

The primary search unit 144 is a processing unit to search the search data storing unit 130 so as to extract search data satisfying the search conditions accepted by the search condition accepting unit 143. The primary search unit 144 extracts the following three types of search data groups.

A first search data group is a group of search data that matches all the search conditions including classification information and a keyword. The target data corresponding to the search data included in the first search data group is determined to satisfy all the search conditions by the primary search unit 144, and is thus output as part of a search result without thorough search by the secondary search unit 145. If the search conditions include a condition in which matching cannot be determined from the search data, the first search data group is empty. For example, if the search data does not include the update date of corresponding target data and if the update date of the target data is specified as a search condition, the first search data group is empty.

A second search data group is a group of search data that matches classification information in the search conditions but that cannot determine whether the search conditions match the other condition including a keyword. For example, if there is search data that matches classification information included in search conditions but that does not match a keyword, matching with the keyword can be determined only by referring to the corresponding target data. Therefore, the search data is included in the second search data group.

A third search data group is a group of search data that does not match classification information in the search conditions but that matches the other condition including a keyword. As described above, search data can be generated by an arbitrary method, and thus a classification name that is not registered in the classification information master 111 can be set as classification information. The search data having such an unregistered classification name set as classification information is not included in a search result because it does not match the search conditions, and thus it is possible that the corresponding target data will not be effectively used. In the data search method according to the embodiment, such search data is extracted as the third search data group, and information about the third search data group is output onto a search result screen, so that target data can be effectively used.

The secondary search unit 145 is a processing unit to search for target data corresponding to the search data included in the second search data group extracted by the primary search unit 144 and extract the target data that matches the search condition other than classification information.

The search result output unit 146 is a processing unit to output a search result. Specifically, the search result output unit 146 outputs, as a search result, information about the target data corresponding to the search data included in the first search data group extracted by the primary search unit 144 and the target data extracted by the secondary search unit 145. Furthermore, the search result output unit 146 outputs, as a search result, the classification information held in the search data included in the third search data group extracted by the primary search unit 144.

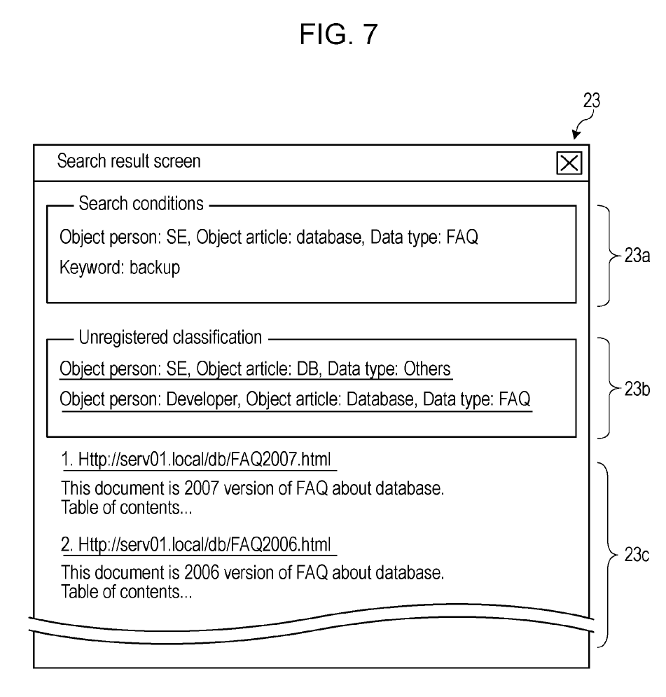

FIG. 7 illustrates an example of a search result screen 23 output by the search result output unit 146. Display of the search result screen 23 is realized when the search result output unit 146 generates an HTML file to display this screen and transmits the HTML file to a WEB browser provided in the terminal apparatus as a source of a request. The search result screen 23 illustrated in FIG. 7 includes an area 23a to display specified search conditions; an area 23b to display classification information held in the search data included in the third search data group; and an area 23c to display information about the target data corresponding to the search data included in the first search data group extracted by the primary search unit 144 and the target data extracted by the secondary search unit 145.

The information about each piece of target data displayed in the area 23c includes a link embedded with the URL of the target data. The user can access the substance of a target file by selecting this link by using a mouse or the like.

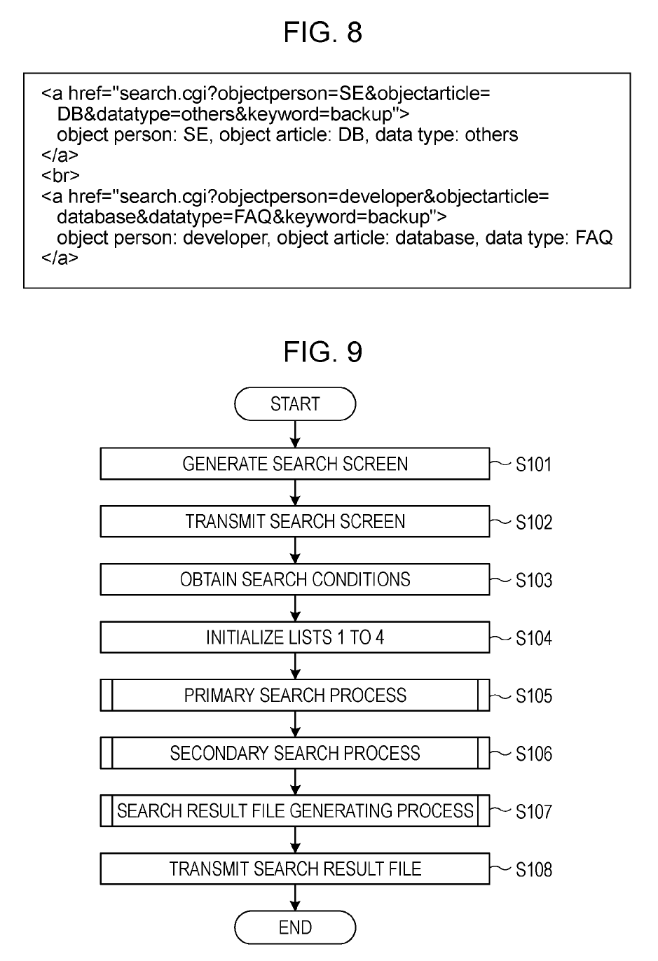

The area 23b shows a list of combination patterns of classification names in the classification information included in the search data that matches the keyword but that does not match the classification information. In this example, combination patterns of the classification names registered in the classification information master 111 are not displayed in order to prevent complicated display. As indicated by the HTML source illustrated in FIG. 8, a combination pattern of the respective classification names includes a link that is set to execute re-search by specifying the combination pattern of the classification names as a search condition.

For example, assume that the link set in the combination “object person: SE, object article: DB, data type: others” is clicked. In this case, a search process is performed in the same search conditions as in the case where “SE” is selected as an object person, “DB” is selected as an object article, “others” is selected as a data type, and the same value as that of the previous search is set as a keyword on the search screen. The classification name “DB” as an object article does not exist in the classification information master 111, and thus the search data in which the classification name “DB” is mistakenly set as an object article is less likely to be searched for from the search screen output by the search screen output unit. Such search data can be easily searched for when the search result output unit 146 displays classification information held in the search data included in the third search data group and sets an appropriate link.

Next, procedures of processes performed by the data search apparatus 10 illustrated in FIG. 2 is described. The following description about the procedures is given based on the assumption that search conditions include only classification information and a keyword, in order to simplify the description.

FIG. 9 is a flowchart illustrating a procedure of a search process performed by the data search apparatus 10. As illustrated in FIG. 9, after the data search apparatus 10 has received a search request from any of the terminal apparatuses 20a to 20n, the search screen output unit 142 generates a search screen (step S101) and transmits the search screen to the source of the request (step S102). Then, the search condition accepting unit 143 obtains search conditions input on the search screen (step S103).

Then, after the control unit 140 has initialized lists 1 to 4 (step S104), the primary search unit 144 performs a primary search process described below (step S105), and the secondary search unit 145 performs a secondary search process described below (step S106). Then, the search result output unit 146 performs a search result file generating process described below (step S107) and transmits the generated search result file to the source of the request (step S108).

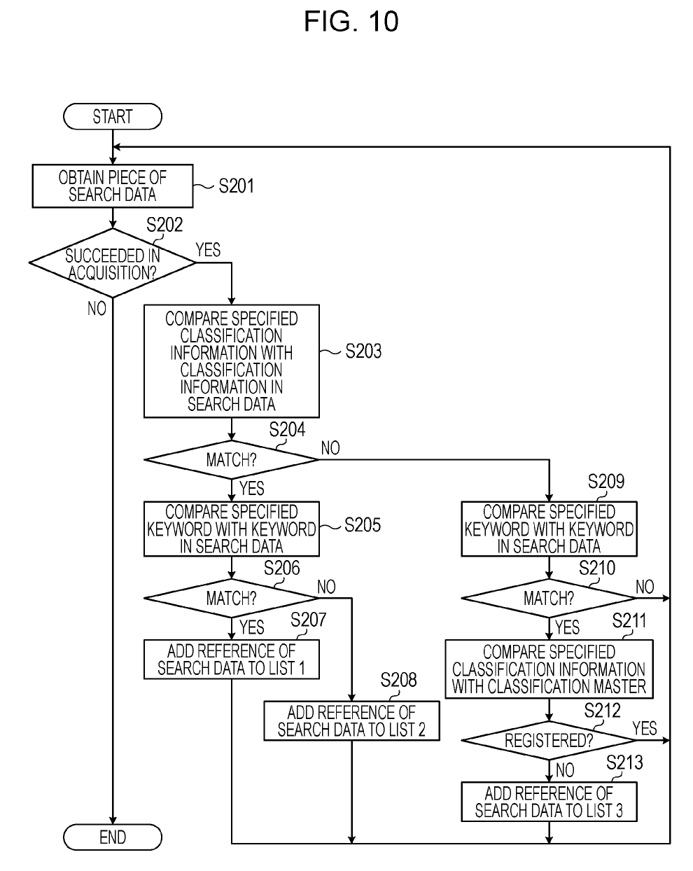

FIG. 10 is a flowchart illustrating a procedure of the primary search process. As illustrated in FIG. 10, the primary search unit 144 obtains a piece of search data from the search data storing unit 130 (step S201). If a piece of search data can be obtained (YES in step S202), the primary search unit 144 compares the classification information specified as a search condition with the classification information included in the obtained search data (step S203).

If the both pieces of classification information match each other (YES in step S204), the primary search unit 144 further compares the keyword specified as a search condition with the keyword included in the obtained search data (step S205). The matching between the keywords need not be determined by perfect matching, and may be determined based on a matching rule used in typical keyword search.

If the keywords match each other (YES in step S206), the primary search unit 144 sets a reference of the obtained search data to the list 1 (step S207). If the keywords do not match each other (NO in step S206), the primary search unit 144 sets the reference of the obtained search data to the list 2 (step S208). Then, the primary search unit 144 restarts the process from step S201 and tries to obtain another piece of search data.

On the other hand, if both pieces classification information do not match each other (NO in step S204), the primary search unit 144 compares the keyword specified as a search condition with the keyword included in the obtained search data (step S209). If the keywords match each other (YES in step S210), the primary search unit 144 compares the classification information specified as a search condition with the classification information master 111 (step S211). If there is an unregistered classification name in the classification names included in the classification information specified as a search condition (NO in step S212), the primary search unit 144 sets the reference of the obtained search data to the list 3 (step S213).

Then, the primary search unit 144 restarts the process from step S201 and tries to obtain another piece of search data. If the keywords match each other in step S209, the reference of the search data may be unconditionally set to the list 3 without performing comparison with the classification information master 111.

If the keywords do not match each other in step S209 (NO in step S210) or if all the classification names included in the classification information specified as a search condition have been registered in the classification information master 111 in step S211 (YES in step S212), the primary search unit 144 does not set the reference of the obtained search data to any list and restarts the process from step S201 so as to try to obtain another piece of search data.

In this way, the process is performed on each piece of search data. After obtaining all pieces of search data in step S201 (NO in step S202), the primary search unit 144 ends the process.

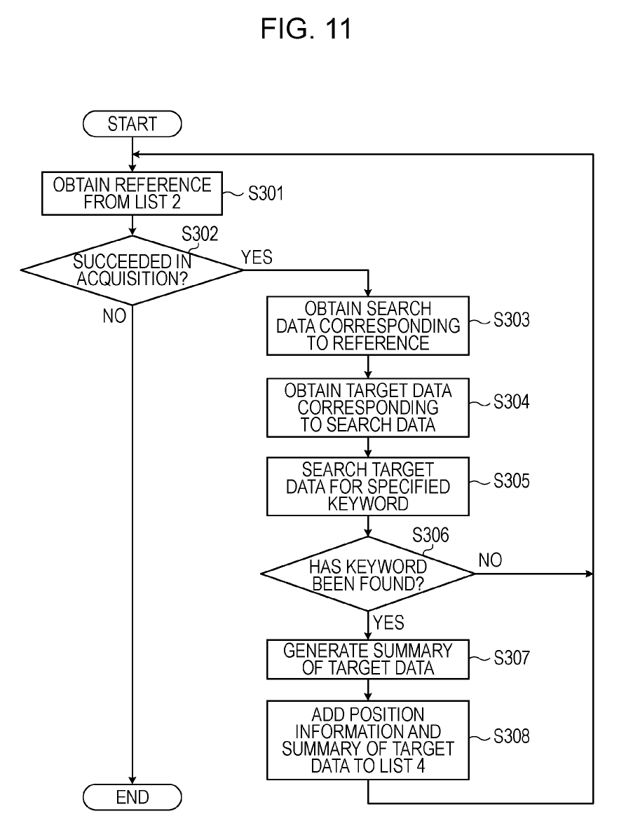

FIG. 11 is a flowchart illustrating a procedure of the secondary search process. As illustrated in FIG. 11, the secondary search unit 145 obtains a reference from the list 2 (step S301). If the reference can be obtained (YES in step S302), the secondary search unit 145 obtains the search data corresponding to the reference (step S303) and further obtains the target data indicated by the position information of the obtained search data (step S304).

Then, the secondary search unit 145 searches the obtained target data for a keyword specified as a search condition (step S305). If the keyword has been found (YES in step S306), the secondary search unit 145 generates a summary of the obtained target data (step S307) and adds the position information and summary of the obtained target data to the list 4 by associating them with each other (step S308). Then, the secondary search unit 145 restarts the process from step S301 and tries to obtain another reference.

On the other hand, if the keyword is not found in step S305 (NO in step S306), the secondary search unit 145 adds something to the list 4 and restarts the process from step S301 so as to try to obtain another reference.

In this way, the process is performed on each reference in the list 2. After all references have been obtained in step S301 (NO in step S302), the secondary search unit 145 ends the process.

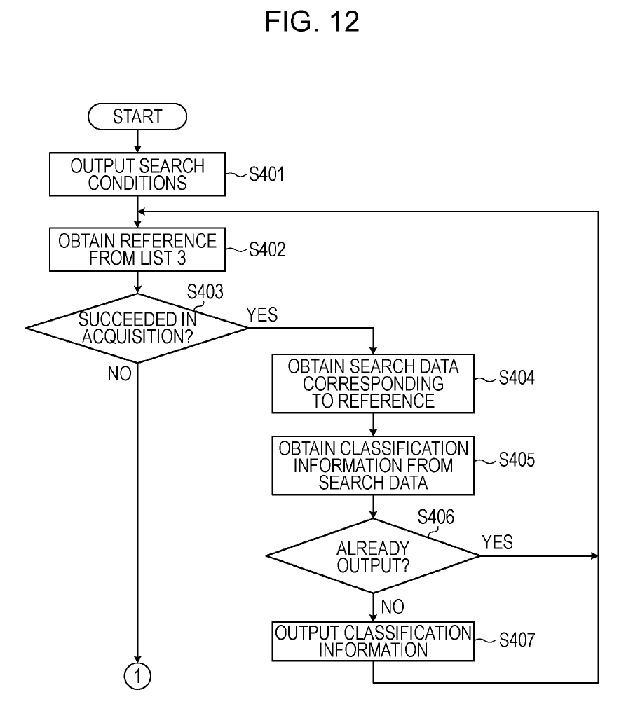

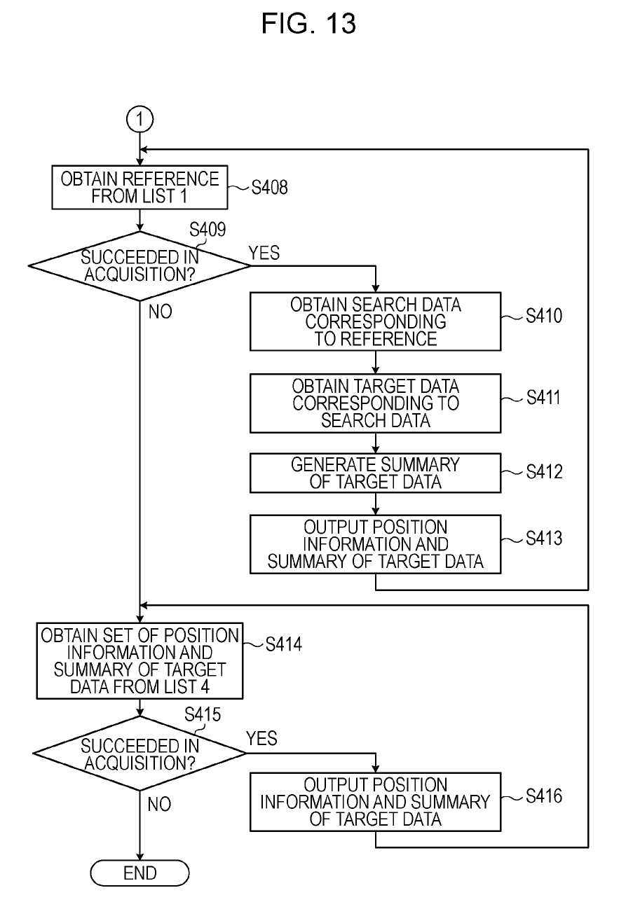

FIGS. 12 to 13 are flowcharts illustrating a procedure of the search result file generating process. As illustrated in FIGS. 12 and 13, the search result output unit 146 outputs search conditions to a search result file (step S401). Then, the search result output unit 146 obtains a reference from the list 3 (step S402). If the reference can be obtained (YES in step S403), the search result output unit 146 obtains the search data corresponding to the reference (step S404).

Then, the search result output unit 146 obtains classification information from the obtained search data (step S405). If a combination of the classification names included in the classification information has not been output (NO in step S406), the search result output unit 146 adds the link for re-search as illustrated in FIG. 8 and outputs the combination of the classification names to the search result file (step S407). Then, the search result output unit 146 restarts the process from step S402 and tries to obtain another reference.

On the other hand, if the combination of the classification names has been output in step S405 (YES in step S406), the search result output unit 146 does not output the combination of the classification names and restarts the process from step S402 so as to try to obtain another reference.

In this way, the process is performed on each reference of the list 3. After all references have been obtained in step S402 (NO in step S403), the search result output unit 146 proceeds to step S408.

After completing the process about the list 3, the search result output unit 146 obtains a reference from the list 1 (step S408). If the reference can be obtained (YES in step S409), the search result output unit 146 obtains the search data corresponding to the reference (step S410) and further obtains the target data indicated by the position information of the obtained search data (step S411). Then, the search result output unit 146 generates a summary of the obtained target data (step S412) and outputs the position information and summary of the obtained target data to the search result file (step S413). Then, the search result output unit 146 restarts the process from step S408 and tries to obtain another reference.

In this way, the process is performed on each reference of the list 1. After all references have been obtained in step S408 (NO in step S409), the search result output unit 146 proceeds to step S414.

After completing the process about the list 1, the search result output unit 146 obtains a set of position information and summary from the list 4 (step S414). If the set can be obtained (YES in step S415), the search result output unit 146 outputs the position information and the summary to the search result file (step S416). Then, the search result output unit 146 restarts the process from step S414 and tries to obtain another set of position information and summary.

In this way, the process is performed on the list 4. After all sets of position information and summary have been obtained in step S414 (NO in step S415), the search result output unit 146 ends the search result file generating process.

The configuration of the data search apparatus 10 according to the embodiment illustrated in FIG. 2 can be variously changed without deviating from the scope of the present invention. For example, by mounting the function of the control unit 140 of the data search apparatus 10 in the form of software and executing it in a computer, the function equivalent to that of the data search apparatus 10 can be realized. Hereinafter, a description is given about an example of a computer to execute a data search program 1071 that is the function of the control unit 140 mounted as software.

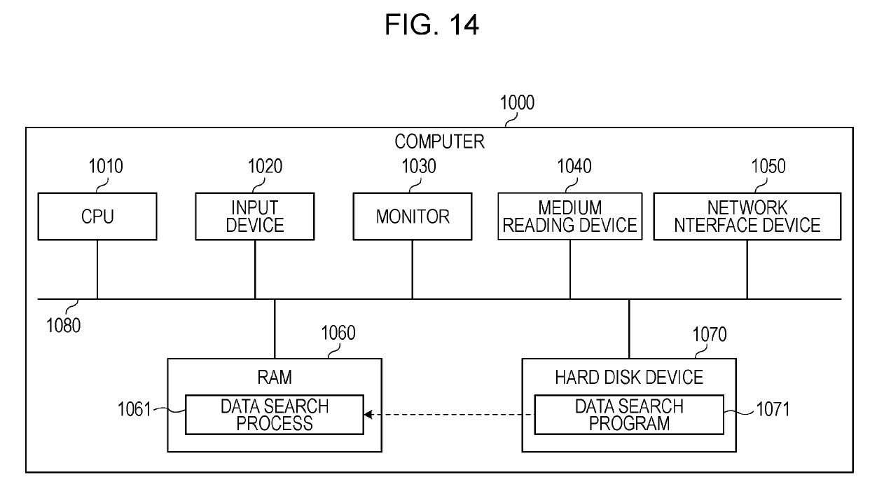

FIG. 14 is a functional block diagram illustrating a computer 1000 to execute the data search program 1071. The computer 1000 includes a CPU (Central Processing Unit) 1010 to execute various types of processing; an input device 1020 to accept input of data from a user; a monitor 1030 to display various pieces of information; a medium reading device 1040 to read a program and so on from a recording medium; a network interface device 1050 to transmit/receive data to/from another computer via a network; a RAM (Random Access Memory) 1060 to temporarily store various pieces of information; and a hard disk device 1070, which are mutually connected via a bus 1080.

The hard disk device 1070 stores the data search program 1071 having the same function as that of the control unit 140 illustrated in FIG. 2. When the CPU 1010 reads the data search program 1071 from the hard disk device 1070 and expands it in the RAM 1060, the data search program 1071 functions as a data search process 1061.

Then, the data search process 1061 appropriately expands information read from the hard disk device 1070 or the like in an area assigned thereto in the RAM 1060 and performs various types of data processing based on the expanded data.

The data search program 1071 need not always be stored in the hard disk device 1070. Alternatively, the program may be stored in a storage medium such as a CD-ROM and the computer 1000 may read and executes the program. Alternatively, the program may be stored in another computer (or a server) connected to the computer 1000 via a public line, the Internet, a LAN (Local Area Network), a WAN (Wide Area Network), or the like, and the computer 1000 may read the program therefrom and execute the program.

As described above, according to the embodiment, a database that is managed in a centralized manner is not used, and data search is performed based on search data that is managed in pairs with target data. Accordingly, target data can be efficiently searched for without increasing a load for operation/maintenance.

What is claimed is:

1. A computer-readable recording medium carrying a data search program to search for target data based on a keyword included in the target data and classification information indicating classification of the target data, the data search program allowing a computer to execute:
a search condition accepting step of accepting the keyword and the classification information as search conditions;
a first search step of searching for search data that is generated in tandem with the target data and that holds position information indicating a position of corresponding target data and classification information of the corresponding target data while associating the position information with the classification information, and selecting search data holding the classification information accepted in the search condition accepting step;
a second search step of searching for target data indicated by the position information held in the search data selected in the first search step and selecting target data including the keyword accepted in the search condition accepting step; and
a search result output step of outputting information about the target data selected in the second search step.

2. The computer-readable recording medium carrying the data search program according to claim 1,
wherein the search data further holds part of the keyword included in the corresponding target data,
wherein the first search step searches for the search data and selects (a) a first search data group holding the keyword and the classification information accepted in the search condition accepting step, and (b) a second search data group not holding the keyword accepted in the search condition accepting step but holding the classification information,
wherein the second search step searches for the target data indicated by the position information held in the search data included in the second search data group and selects target data including the keyword accepted in the search condition accepting step, and
wherein the search result output step outputs information about the target data indicated by the position information held in the search data included in the first search data group and information about the target data selected in the second search step.

3. The computer-readable recording medium carrying the data search program according to claim 2,
wherein the first search step searches for the search data and further selects a third search data group holding the keyword accepted in the search condition accepting step but not holding the classification information, and
wherein the search result output step further outputs classification information held in the search data included in the third search data group.

4. A data search apparatus to search for target data based on a keyword included in the target data and classification information indicating classification of the target data, the data search apparatus comprising:
search condition accepting means for accepting the keyword and the classification information as search conditions;
first search means for searching for search data that is generated in tandem with the target data and that holds position information indicating a position of corresponding target data and classification information of the corresponding target data while associating the position information with the classification information, and selecting search data holding the classification information accepted by the search condition accepting means;
second search means for searching for target data indicated by the position information held in the search data selected by the first search means and selecting target data including the keyword accepted by the search condition accepting means; and
search result output means for outputting information about the target data selected by the second search means.

5. The data search apparatus according to claim 4,
wherein the search data further holds part of the keyword included in the corresponding target data,
wherein the first search means searches for the search data and selects (a) a first search data group holding the keyword and the classification information accepted by the search condition accepting means, and (b) a second search data group not holding the keyword accepted by the search condition accepting means but holding the classification information,
wherein the second search means searches for the target data indicated by the position information held in the search data included in the second search data group and selects target data including the keyword accepted by the search condition accepting means, and
wherein the search result output means outputs information about the target data indicated by the position information held in the search data included in the first search data group and information about the target data selected by the second search means.

6. The data search apparatus according to claim 5,
wherein the first search means searches for the search data and further selects a third search data group holding the keyword accepted by the search condition accepting means but not holding the classification information, and
wherein the search result output means further outputs classification information held in the search data included in the third search data group.

7. A data search method for searching for target data based on a keyword included in the target data and classification information indicating classification of the target data, the data search method comprising:
a search condition accepting step of accepting the keyword and the classification information as search conditions;
a first search step of searching for search data that is generated in tandem with the target data and that holds position information indicating a position of corresponding target data and classification information of the corresponding target data while associating the position information with the classification information, and selecting search data holding the classification information accepted in the search condition accepting step;
a second search step of (a) searching for target data indicated by the position information held in the search data selected in the first search step and (b) selecting target data including the keyword accepted in the search condition accepting step; and
a search result output step of outputting information about the target data selected in the second search step.

8. The data search method according to claim 7,
wherein the search data further holds part of the keyword included in the corresponding target data,
wherein the first search step searches for the search data and selects a first search data group holding the keyword and the classification information accepted in the search condition accepting step and a second search data group not holding the keyword accepted in the search condition accepting step but holding the classification information,
wherein the second search step searches for the target data indicated by the position information held in the search data included in the second search data group and selects target data including the keyword accepted in the search condition accepting step, and
wherein the search result output step outputs information about the target data indicated by the position information held in the search data included in the first search data group and information about the target data selected in the second search step.

9. The data search method according to claim 8,
wherein the first search step searches for the search data and further selects a third search data group holding the keyword accepted in the search condition accepting step but not holding the classification information, and
wherein the search result output step further outputs classification information held in the search data included in the third search data group.
